(19) United States
(12) Patent Application Publication
(10) Pub. No.: US 2016/0360409 A1
(43) Pub. Date: Dec. 8, 2016

(54) SYSTEM AND PROCESS FOR CONTROLLING A PORTABLE DEVICE

(71) Applicant: Avinash Vijai SINGH, Manorhaven, NY (US)

(72) Inventor: Avinash Vijai SINGH, Manorhaven, NY (US)

(21) Appl. No.: 15/241,910

(22) Filed: Aug. 19, 2016

Related U.S. Application Data
(63) Continuation of application No. 14/569,403, filed on Dec. 12, 2014.
(60) Provisional application No. 62/350,652, filed on Jun. 15, 2016.
(60) Provisional application No. 61/916,766, filed on Dec. 16, 2013.

(51) Int. Cl. H04W 12/06; H04M 1/725; G06K 9/00; H04L 29/06

(52) U.S. Cl. CPC H04W 12/06; H04L 63/083; H04L 63/0861; H04M 1/72577; G06K 9/00006; G06K 9/00597

(57) ABSTRACT

There is disclosed a process for remotely controlling an electronic device including steps which include presenting a login screen, presenting a plurality of different login steps comprising at least one of a password and an additional login step, connecting the device to a remote server to confirm the password and the identity of the user and unlocking at least one application upon a confirmation of the password and the identity of the user.

### CROSS REFERENCE TO RELATED APPLICATIONS

This application is a continuation in part application of U.S. application Ser. No. 14/569,403 filed on Dec. 12, 2014, which is a non-provisional application and that application claims priority from U.S. Provisional Patent Application Ser. No. 61/916,766 filed on Dec. 16, 2013. This application is also a non-provisional application which claims priority from U.S. Provisional Patent Application Ser. No. 62/350,652 filed on Jun. 15, 2016 the disclosure of which is hereby incorporated herein by reference.

### BACKGROUND

One embodiment of the invention relates to a system and process for controlling a portable device such as a telephone or a tablet using a unique set of codes so that different applications can be controlled based upon different user authentications.

There is a need for parents or other parties in authority to control the access to applications and to components of an electronic device. For example, if parents did not want their children using a portable phone for unauthorized purposes or during unauthorized times it would be hard to control the child's behavior without some application or device for controlling the use of the remote electronic device.

Therefore, there is a need for a system and process that includes the ability to limit access to specific applications on a specific device and to set timers for each of the applications or even for use of the entire device based upon login codes as well. The system and process can be used to control other electronic devices as well as simply the applications associated with the different electronic devices. The system and process can also reward users for their beneficial behavior.

### SUMMARY

At least one embodiment of the invention relates to a system and process for controlling the use of an application or machine such as a mobile telephone or a mobile electronic device application through the use of unique codes. In addition, at least one embodiment relates to a system and process for controlling these codes using different timers on each of these applications.

For example, there can be a system process for controlling the authentication of a user with a device. The device can have a memory and a microprocessor. The process can comprise a series of steps such as setting user permissions on a device via a series of instructions sent to the processor and storing these user permissions in the memory of the device. Another step can include limiting access to a device to particular users of the device based upon the identity of the user. Another step can include limiting access to the device to particular users based upon the time of day of use of the device. Another step can include locking access to the device including locking functionality of at least one component of the device to prevent use outside of a time of day of use. Another step can include limiting the use of applications or duration of use of the applications based upon the location of the device at the time of login or the location of the device at the time of use. In at least one embodiment, depending on the location of the device, a login screen is selectively presented or hidden from the user.

To control a remote device an application can be downloaded and then associated with a device. The controlling of the downloading of the device can be initiated by an administrator who controls whether a party can use the device. The administrator can require that this application or program is installed on the device before further access to the device is allowed.

In addition, there is also a device which has internal switches which can be switched on or off based upon remote control from an administrator.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a schematic block diagram of the system for use with the process for setting various user permissions on a device such as a mobile device;

FIG. 2A is a schematic block diagram of the server side components for use with setting an application;

FIG. 2B is a schematic block diagram of the device side components for use which handles the application;

FIG. 3 is a flow chart for the process for setting up a user with a system;

FIG. 4 is a flow chart for the process for allowing a user to login and restricting access to particular features or applications on a device;

FIG. 5 is a flow chart for the process for allowing an administrator to set time limits or the time of the week for use of a device or particular applications for use with a user;

FIG. 6 is a flow chart for the login and restriction of applications and features after a particular time period or day or date;

FIG. 7 is a schematic block diagram of a switching layout for another embodiment;

FIG. 8 is a block diagram of the different devices that can be controlled by an administrator;

FIG. 9 is a view of a screen for controlling remote devices;

FIG. 10 is a flow chart of another embodiment for controlling remote devices;

FIG. 11 is a flow chart of another embodiment for controlling remote devices;

FIG. 12 is a flow chart of another embodiment for controlling remote devices;

FIG. 13 is a flow chart of another embodiment;

FIG. 14 is a flow chart of another embodiment; and

FIG. 15 is a flow chart of another embodiment;

FIG. 16 is a block diagram of another embodiment;

FIG. 17A is a schematic diagram of a docking station;

FIG. 17B is a schematic diagram of the lock and key for the docking station;

FIG. 17C is a schematic diagram of another lock and key;

FIG. 18 is a view of another flow chart; and

FIG. 19 is a flow chart for rewarding users with additional time depending on a level of beneficial activity.

### DETAILED DESCRIPTION

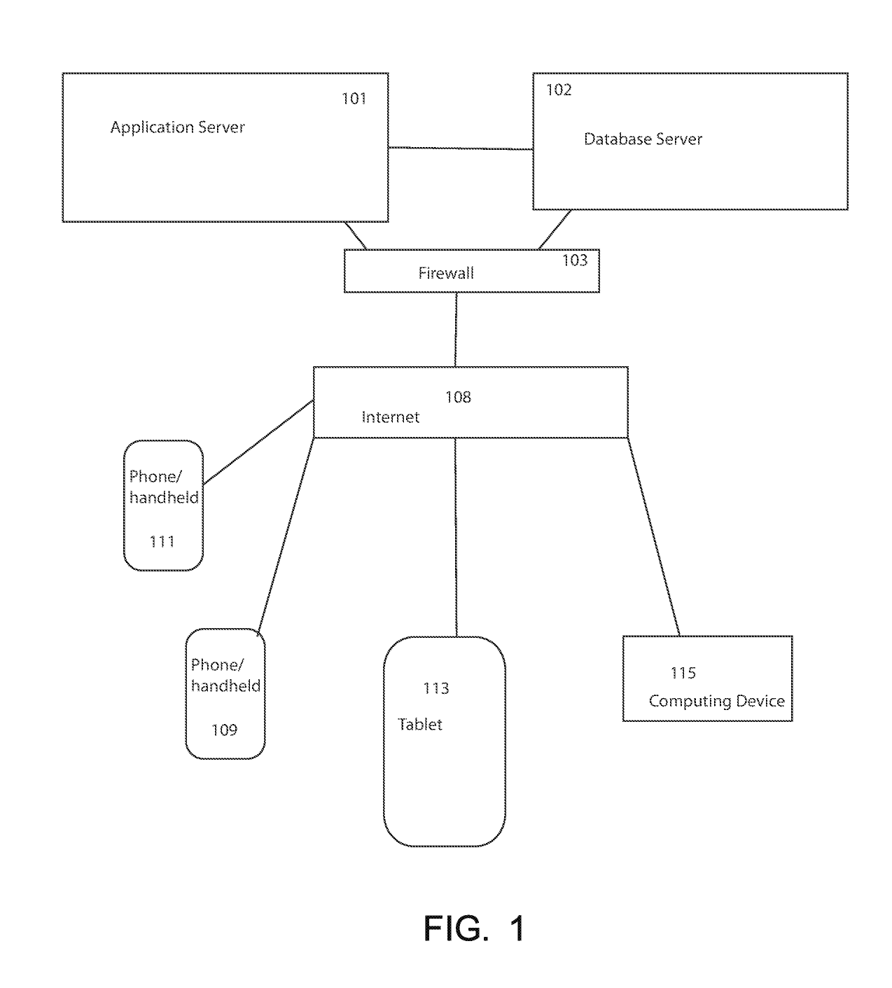

Turning now in detail to the drawings, FIG. 1 is a schematic block diagram of the system for use with the process for setting various user permissions on a device such as a mobile device. With this system there is an application server 101 and a database server 102. These two servers can be disposed behind a firewall such as firewall 103.

Each of these servers can be in the form of a single stand-alone server or multiple servers distributed across a cloud or network. These servers are in communication with other computing devices through a network such as the world wide web or internet 108.

There can be multiple different devices such as mobile devices such as a phone or handheld device 111, a phone or handheld device 109, a tablet 113 or any other suitable type computing device 115 in communication through internet 108 to application server 101 and/or database server 102.

These servers such as application server 101 and/or database server 102 can be used to control the permissions on the different distributed computing devices 109, 111, 113, and 115. These servers are in at least one embodiment administrator devices, while the other devices such as devices 109, 111, 113, and 115 are remote or first devices. In at least one embodiment, the first device can be an administrator device as well, wherein an administrator can program in user settings on the device itself as well.

For example, user permissions can be controlled at the individual device level such as on phone/handheld 111 or application server 101 can for example, be used to control the access to the device as well as to particular applications on the device as well, wherein this control or authentication can be entirely different from that required from the stand alone device. The control can be used to control both the operating system and the physical components themselves so that the instructions stored in memory can lock any one of the physical components.

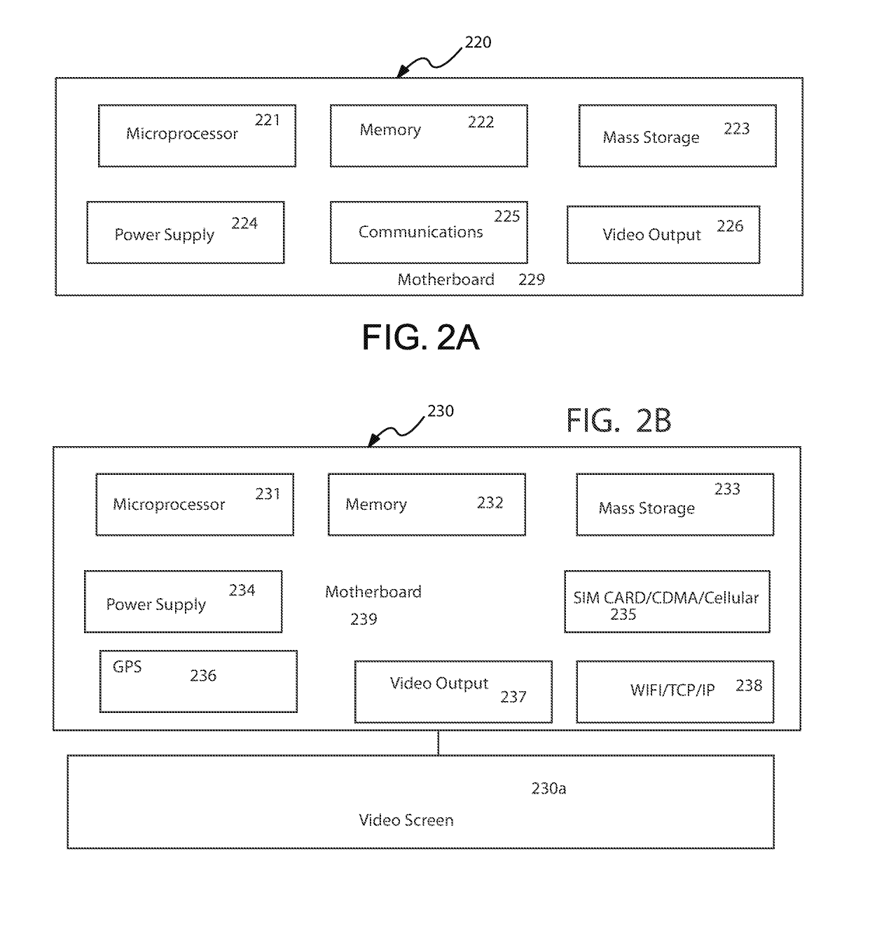

FIG. 2A is a schematic block diagram of the components that can be used in the computing device. For example, there is disclosed a motherboard 229, which is configured to house a microprocessor 221. In addition, also coupled to motherboard 229 is a memory 222, a mass storage 223, a power supply 224, a communications port 225, and an optional video output 226. Power supply 224 provides power output throughout the device and is used to provide power to all of these components. The microprocessor 221, memory 222, mass storage 223, communications port 225, and video output 226 are all in communication with each other. Microprocessor 221 can be in the form of any suitable microprocessor such as an Intel based microprocessor or an AMD based microprocessor.

FIG. 2B is a schematic block diagram of the device side components which handles the application. These components are the type of components that can be typically found in the handheld or portable devices such as devices 109, 111, 113, and 115. All of the components in this device are similar such as microprocessor 231, vs. microprocessor 221 or memory 232 vs. memory 222, or mass storage 233 vs. mass storage 223, or motherboard 239 vs. motherboard 229 or power supply 234 vs. power supply 224 or video output 237 vs. video output 226. Essentially, the only features that are different with the portable devices is the presence of a GPS 236, a WIFI transceiver 238, and a cellular transceiver and sim card 235. The video screen 230a is also integrated into the device as well.

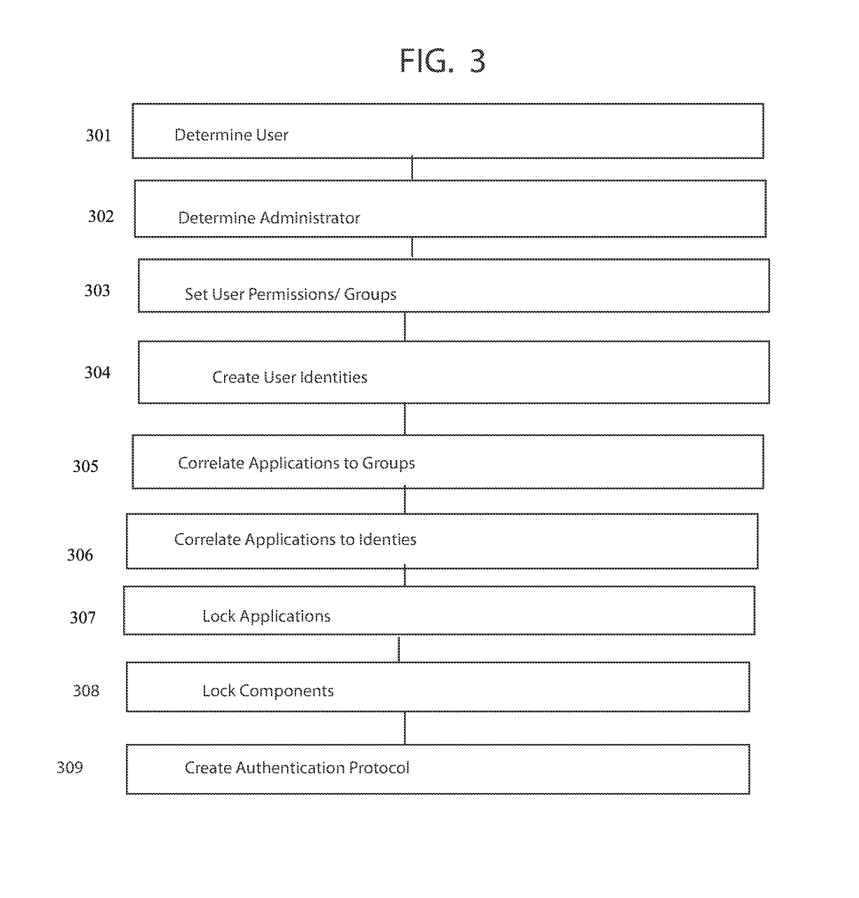

FIG. 3 is a flow chart for the process for setting up a user with a system. In this process, the process starts with step 301 wherein the system determines the user via an initial login. At this initial login, the administrator is determined such as in step 302 as well as other users. Next, in step 303 a user using the system such as using application server 101 and or an individual device such as device 111, can set user permissions based upon different groups of users.

Next, in step 303 the user can set permissions for users/and groups. For example, the user can set permissions for an administrator level such as in step 302, or other more restricted levels such as general user, or even below that such as emergency user. An emergency user is only allowed to make a telephone call using the portable device and is not granted access to the remainder of the applications in the device.

Next, in step 304 the user can create more user identities. Each user can have an identity which includes their personal information, as well as an association to a particular group based upon user permissions. Next, in step 305 the user can correlate different applications to different groups. For example, an administrator group would have access to multiple different applications, wherein a general user may have a more restricted access to different groups and an even more restricted user such as an emergency user would have even more restricted access to these applications. Each group can have multiple users associated with a particular group. If a user is in a particular group, than that particular group designation sets the maximum amount of freedom for a user in that group. The user can have even more restricted or customizable restrictions for their use in that group.

For example, in step 306 the user can correlate particular applications to identities. This can occur by restricting the use of different applications even further once a user is in a particular group. Thus, if an individual user is part of a general user group and the general user group allows these general users access to the following applications: calendar, telephone, email, photos, the administrator can restrict access for an individual user in that user group even further by for example restricting the rights to photos. All other users in that group would default to being able to use any of the above features however, that individual user would be even further restricted.

Next, in step 307, the administrator can lock these applications so that individual users can only access these applications if they have the requisite permissions. Next, and alternatively or in addition, the user can select which components to lock such as the device itself, the processor, the memory, the screen, or other object that are part of the remote computing device. The locking of the device can occur when the program takes control of the operating system to control individual components of a machine. Thus, the user can select any one of a GPS, microprocessor, screen, audio processor or output, video processor or output, memory etc. The user and or administrator can then selectively disable this component so that it appears inactive to the user and cannot be enabled by the other components or programs in the system.

Next in step 309 the user/administrator can create an administration or authentication protocol wherein the user would log in either with a user id and a password or simply with a password. The password can be in the form of a series of characters, voice authentication, thumbprint, or fingerprint authentication or any other suitable type of authentication. Once these authentications have been created, users can then log in and have access to their applications.

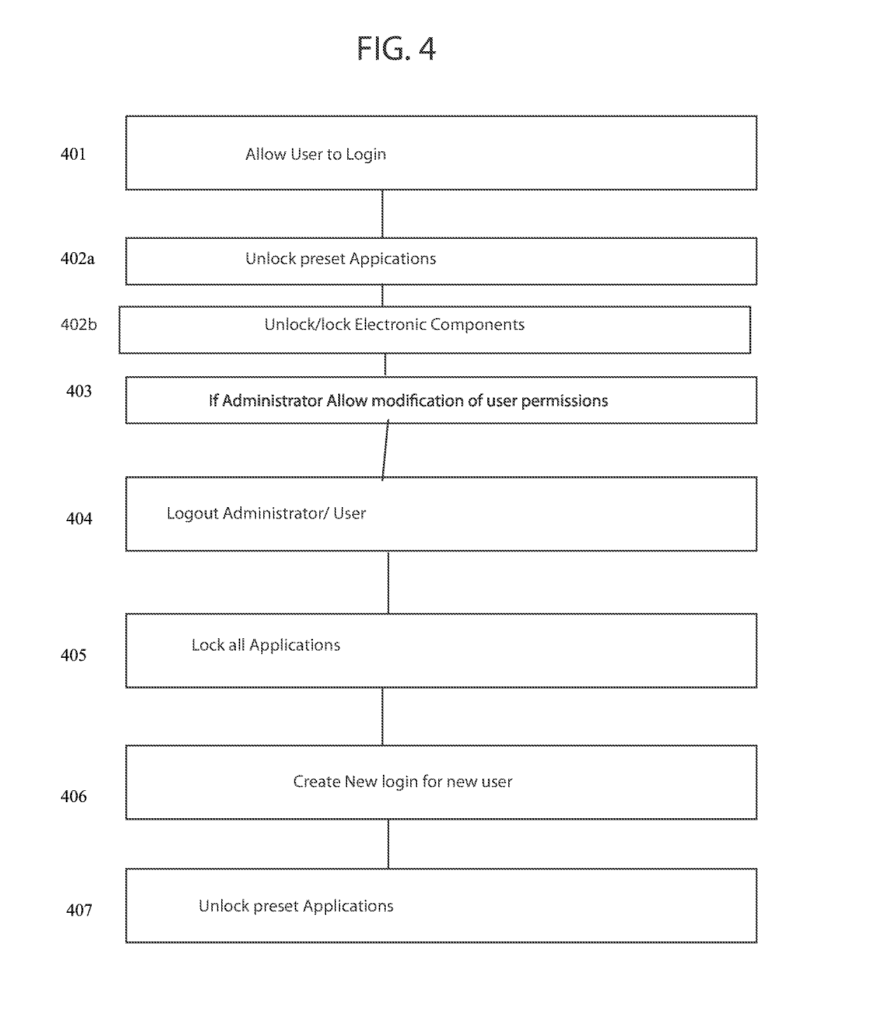

FIG. 4 is a flow chart for the process for allowing a user to login and restricting access to particular features or applications on a device. For example, in step 401 an individual user logs into the device and automatically the preset devices are unlocked in step 402a. Alternatively or in addition, the user/administrator can lock or unlock different electronic components associated with the remote device as well. As listed above, these different electronic components can be in the form of a screen, a microprocessor, audio components, video components, buttons, etc. If the user is an administrator, the user can in step 403 further adjust the permissions for an individual user to use particular applications. Next, if the user is an administrator the user can log out in step 404. Once the user is logged out again this locks out all of the applications again. The user/administrator can also in step 406 create a new login for a new user, wherein as shown in FIG. 3 this can result in the creation of a new administrator, a new general user or a new emergency user. Once this user is created, and once the user logs in again in step 407, the user can unlock all of the preset applications.

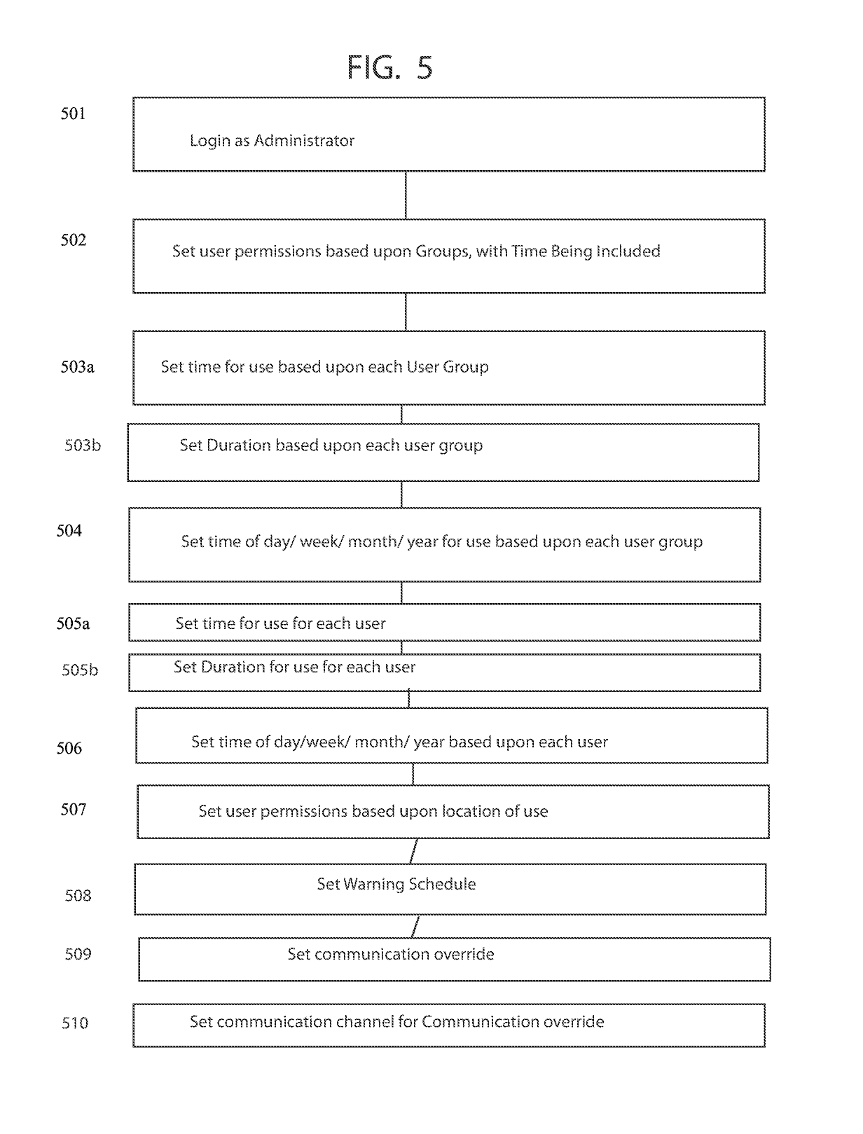

FIG. 5 shows the process for setting the time parameters for use of applications as well. For example, in step 501 the user can log in as an administrator and in step 502 set different user permissions based upon the groups and the time scope that the administrator wants a group to be included. Thus, in step 503a the administrator can set a time for use for each user in each group or institute universal time settings for each group. For example, if the administrator created a group called “kids” or “children” that administrator could restrict the time for use to 5-6 P.M. This way the users who may be kids or children and who log in under that group permissions would not be able to use any applications or any particular applications outside of this time range. Next, in step 503b the user/administrator can set the duration for use of a particular application for a user group. This duration for use can be such as ½ hour, one hour, two hours etc. The duration of use for each user can vary depending on the time of day as well as the location of each user/device. Thus, a particular user may have access to an application for ½ hour between 5-6 P.M. in their home but may only have access to the same application for 15 minutes between the hours of 6-7 P.M. at a location different from their home.

Next, in step 504 the administrator can set the time/day/week/month/year for use for each of the groups of users as described above. In addition, the administrator can in step 505a set these time permissions for each individual user under each group. As indicated above, with the group permissions in place, the subsequent individualized restrictions under this group are only more restrictive for each user in this group. Thus in step 505b the user/administrator can set the duration for use of the application(s) for each user which is distinct from the settings for a particular group as discussed in step 503b. Next, in step 506 the administrator can set the time/day/week/month/year for use for an individual user with these permissions being subject to, and only more restrictive than their associated group permissions.

Next, in step 507 the administrator can set user permissions based upon the location of use. For example, when a user is in a particular pre-set location, a login screen can be withheld from use or presented to the user for login. This geographic location pre-selection can be done so that the user can only use certain applications when that user is within a certain geographic range. This can be done either by identifying GPS coordinates, or geographic distances from a center point such as an address or location within a particular area such as a town, city, state or country. Thus, when the device is in this region, the GPS coordinates of the device being used can be matched to the GPS coordinates stored in the database which is either stored in the mobile device or phone or in the application server or the database server to determine whether to unlock a particular application.

Next, in step 509 the administrator can set a communication override which allows the user to communicate with the administrator to request a temporary override for the restrictions on use. This can be performed by the administrator remotely wherein the administrator can selectively unlock particular applications for the user. In addition, the administrator/user can also select the communication channel for this communication such as via phone, email text, SMS, MMS or other type of communication to obtain additional permissions from the administrator. One means to perform this step is through a web screen wherein the user/administrator changes the user permissions on the fly.

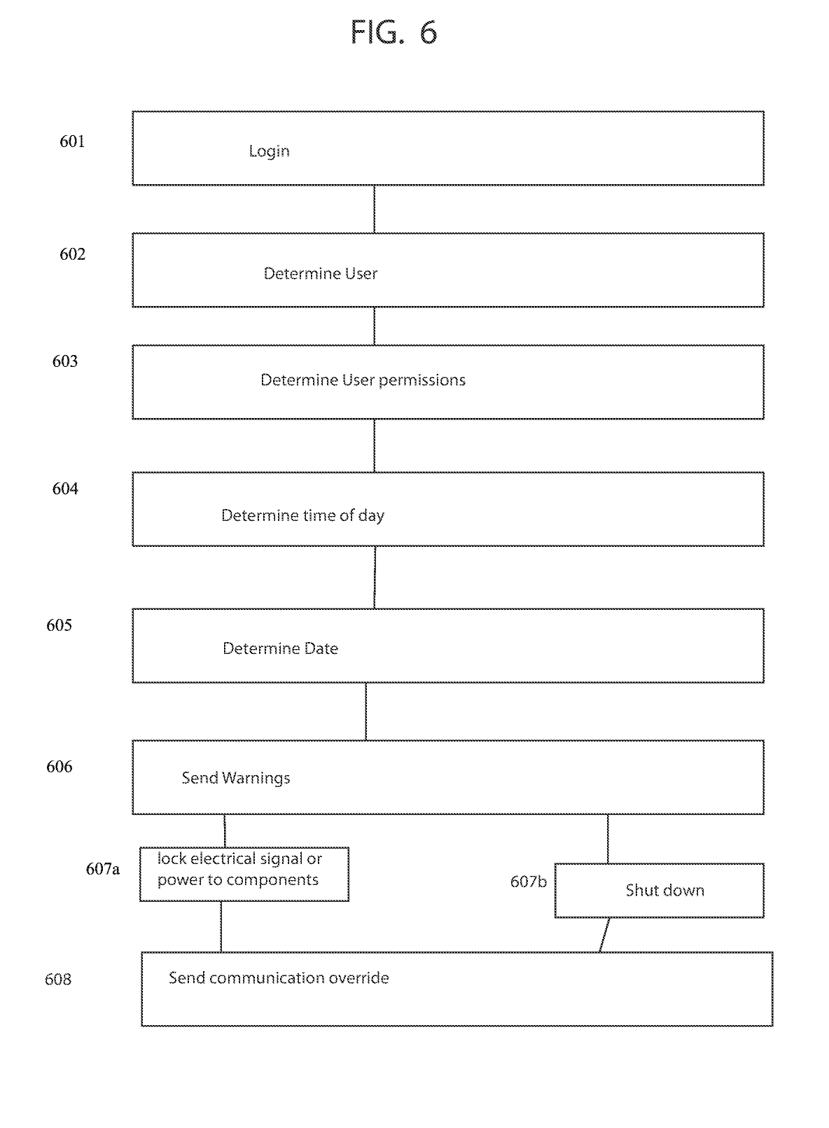

FIG. 6 is a flow chart for the login and restriction of applications and features after a particular time period or day or date. This process starts in step 601 wherein the user can login and then the system determines the type of user that is logged in, in step 602. Next, in step 603, the system can determine the user permissions for that user and unlock only the applications that are authorized for the user. Next, in step 604, the system can determine the time of day for the user, and in step 605 determine the date of user during use. In addition, if the time period is set as a running time from the start of the application, then the system can internally start a clock such as a countdown clock to restrict the use of an application for a predetermined period of time. These predetermined periods of time can vary based upon the different user/user permissions associated with that user and also based upon the time of day the date, month, or year. Next, in step 606 the system can post warnings for the user to tell the user that the application will be locked within a preset period of time. Next, in step 607 the system can shut down the application or even shut down the device or locking of the electrical signal or power. Alternatively, the user can request a communications override either before the application is shut down or after the application is shut down. This request for an override can be in the form of a text, an email or an automatic video chat or telephone call.

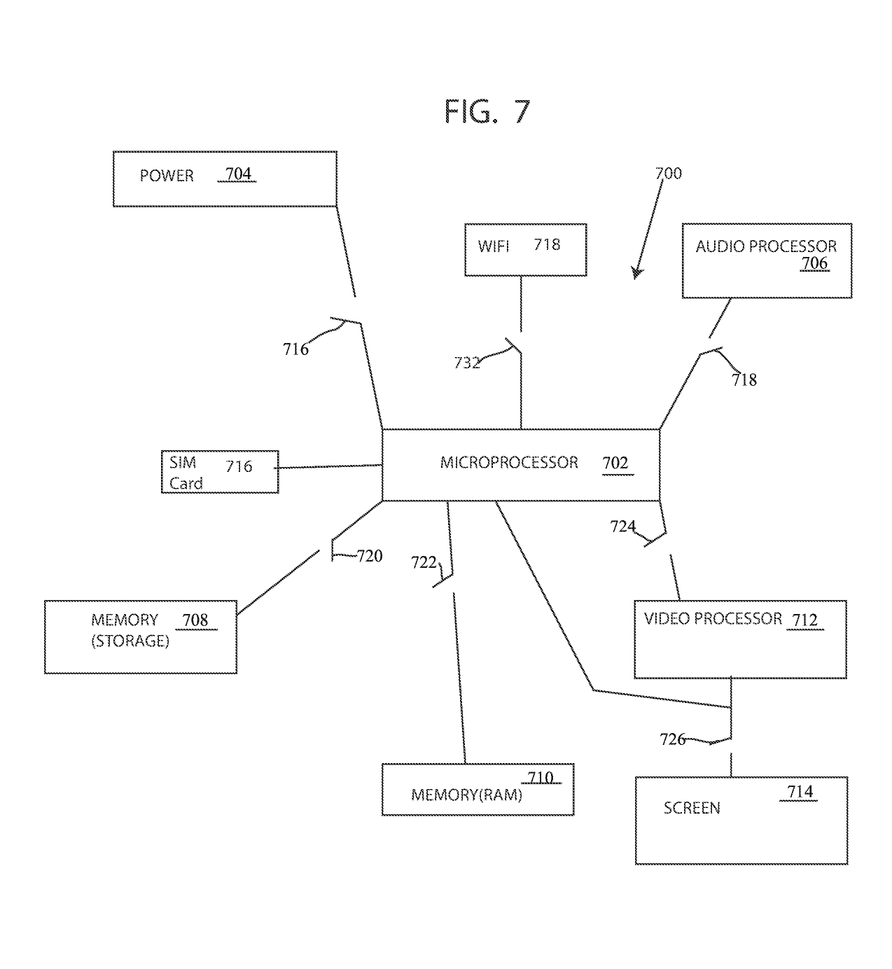

FIG. 7 is a schematic block diagram of a set of components for a remote device such as a telephone 700 or similar type device. This type of device can be in the form of a central microprocessor or CPU 702 in communication with other peripheral electronic components. These electronic components can include a power supply 704, a SIM card 716 for wireless communication, a memory storage unit 708 for storing data on a permanent or semi-permanent basis so as to serve as ROM. A memory or ram 710, a video processor 712, a screen 714 in communication with the video processor 712, and an audio processor 706.

Disposed between these components are switches such as switch 717 disposed between power supply 704 and microprocessor 702, switch 732 disposed between WIFI 718 and microprocessor 702, switch 718 disposed between audio processor 706 and microprocessor 702, switch 724 disposed between video processor 712 and microprocessor 702, switch 726 disposed between video processor 712 and screen 714, switch 722 disposed between microprocessor 702 and memory 710, and switch 720 disposed between microprocessor 702 and memory storage device 708. The microprocessor 702, once it receives instructions from for example a communication from a server to WIFI 718 or from a server to SIM card 716 can then selectively switch any one of the above switches open so that these components lose both power and communication from microprocessor 702 thereby selectively disabling particular components. These components can then be remotely selectively re-activated by communication with microprocessor 702 which can then selectively close any one of the respective switches to connect the peripheral components together with microprocessor 702.

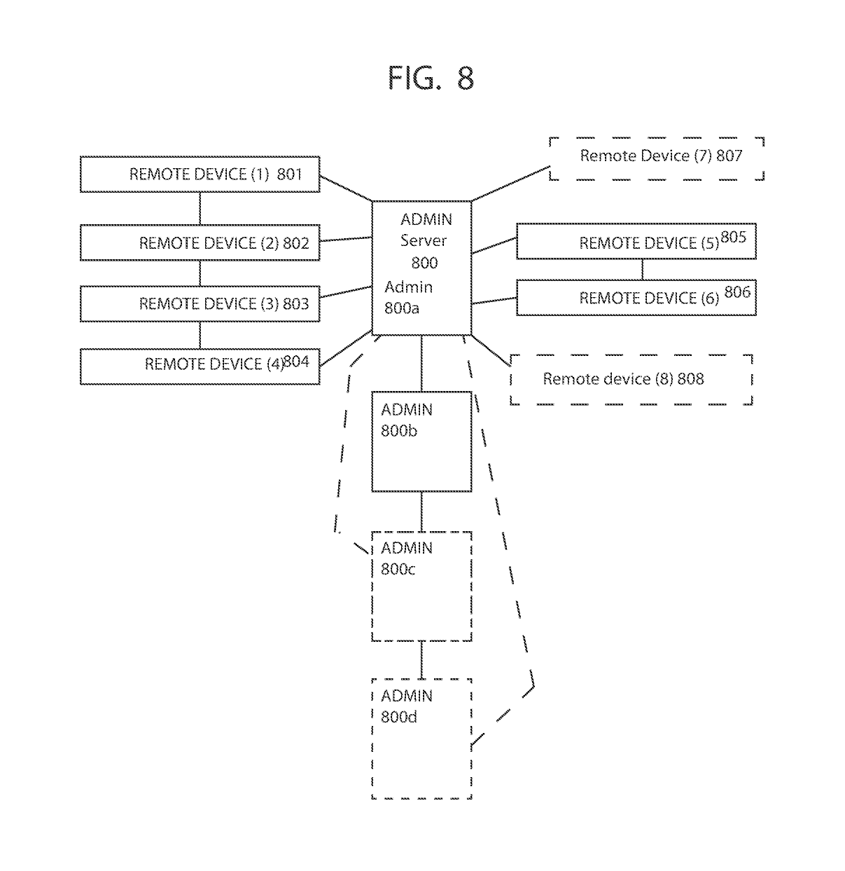

FIG. 8 is a layout of a network which can be used to remotely control different remote devices. For example, there is an administrator server 800 having an administrator 800a which can be in the form of any suitable server such as an application server in communication with a plurality of different remote devices such as remote device (1) 801, remote device (2) 802, remote device (3) 803, remote device (4) 804, remote device (5) 805, remote device (6) 806, remote device (7) 807, and remote device (8) 808.

Both remote device (7) and remote device (8) are configured as additional devices shown with dashed-dotted lines indicating that any number of remote devices such as anyone from one (1) through nearly infinite number of remote devices can be controlled by an administrative server 800 via at least one administrator. There are also a plurality of different administrators shown as well. These administrators can include a primary administrator 800a, or any number of secondary or tertiary, or additional administrators 800b, 800c, 800d etc. Thus if a first administrator is not available to control these electronic devices additional administrators can be used or relied upon to control the remote electronic devices.

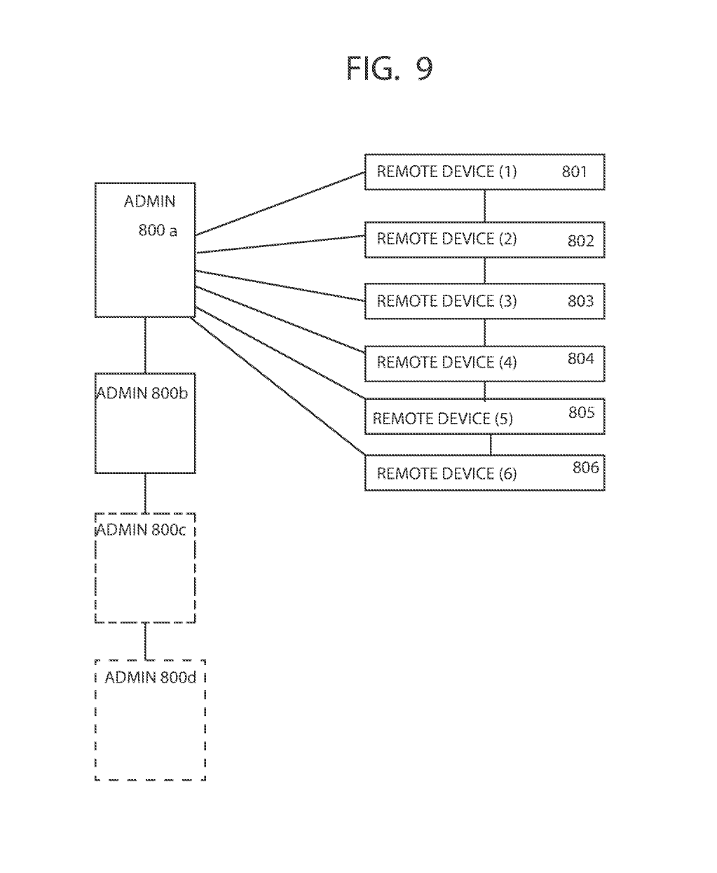

FIG. 9 shows a layout of a screen that can be used for controlling remote devices such as anyone of remote devices 1-6 or more. The administrator who logs in such as anyone of administrators 800a, 800b, 800c, 800d etc, and then control any one of the remote devices also shown in FIG. 8. The administrator can simply select a remote device such as remote device 1 and then selectively turn off any one of the applications stored on that device or turn off any one of the peripheral electronic components on that device as described above in FIG. 7. Thus the administrator is able to control both the applications and also the electronic components remotely from a central screen such as via a web screen.

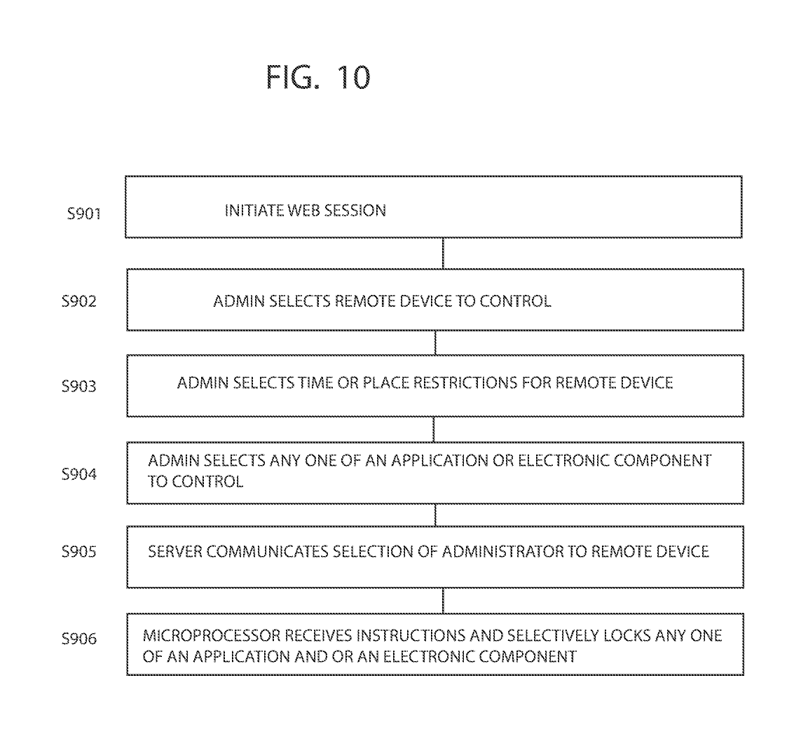

As shown in FIG. 10 thus, to take control of a first or a remote device the administrator device or server such as server 800 can initiate a web session in step S901, allow a user to communicate through the web session to select particular remote device to control in step S902. Next, the administrator in step S903 can select a time or place of restrictions for the remote device such as remote devices 801-806). Next, the administrator in step S904 can select any one of the application or electronic component in that particular remote electronic device to control. Next, in step S905 the server can communicate this selection of the administrator to the selected remote device. This step can be performed simultaneously for multiple remote electronic devices at the same time. Thus, through simultaneous initiated web sessions or communication sessions, the administrative server can communicate these instructions to a plurality of different remote devices simultaneously through simultaneously initiated web sessions and connections with a plurality of different remote devices. As disclosed in the above embodiments the remote devices or first devices 801-808 can also serve as administrator devices and be programmed for selective use directly thereon. The steps or instructions that are stored on the administrative device(s) can also be stored as machine readable program code stored on a medium such as a memory (RAM) or memory storage unit which when uploaded to a microprocessor such as microprocessor 221, 231, or 702, allows the device to perform the functions of the code.

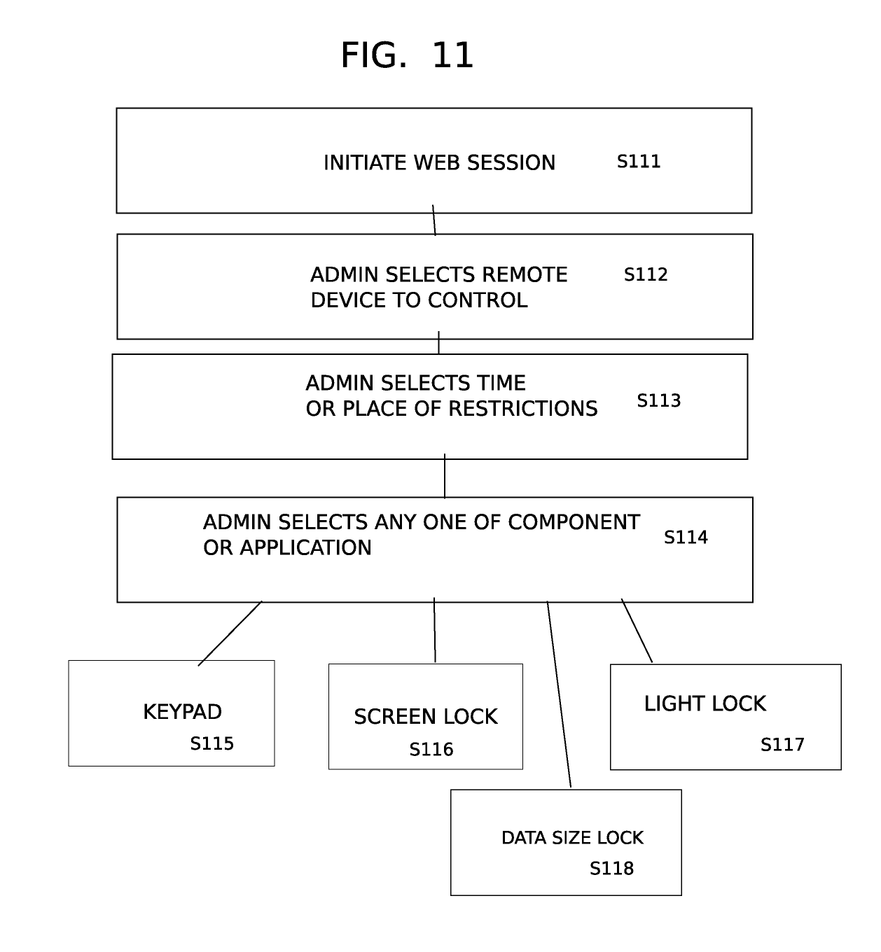

FIG. 11 is a flow chart of another embodiment for controlling remote devices. As described above, for the flow chart of FIGS. 11-15 the term device can mean any device described above. For example, there can be multiple different devices such as mobile devices such as a phone or handheld device 111, a phone or handheld device 109, a tablet 113 or any other suitable type computing device 115 in communication through internet 108 to application server 101 and/or database server 102 as shown for example in FIGS. 1-2B or any of the other FIGS. above.

In this flow chart the system is configured to control the following elements of an electronic device, a keypad, a screen, a light and to also control the amount of data that is being transferred in any one email, SMS, or MMS type text transmission. For example, step S111 includes initiating a web session which is similar to step S901. Next, step S112 involves the administrator selecting a remote control device to control. This step is similar to step S902. Next, in step S113 it involves the administrator selecting a time or place of different restrictions this step is similar to step S903. Next, in step S114 it involves the administrator selecting any one of a particular component or application this step is similar to step S904. In at least one embodiment of this application the administrator can select to control the keypad of the remote device in step S115. Alternatively, or in addition, the administrator can select to selectively lock a screen in step S116. Alternatively, or in addition, the administrator can selectively select to lock the light on the remote device in step S117. Alternatively, or in addition the administrator can selectively select to lock the amount of data that the device either sends or receives in step S118. With this step the system can control the amount or type of data that is sent be the remote device so as to control and prevent overages in a data plan or to prevent certain types of data from being sent.

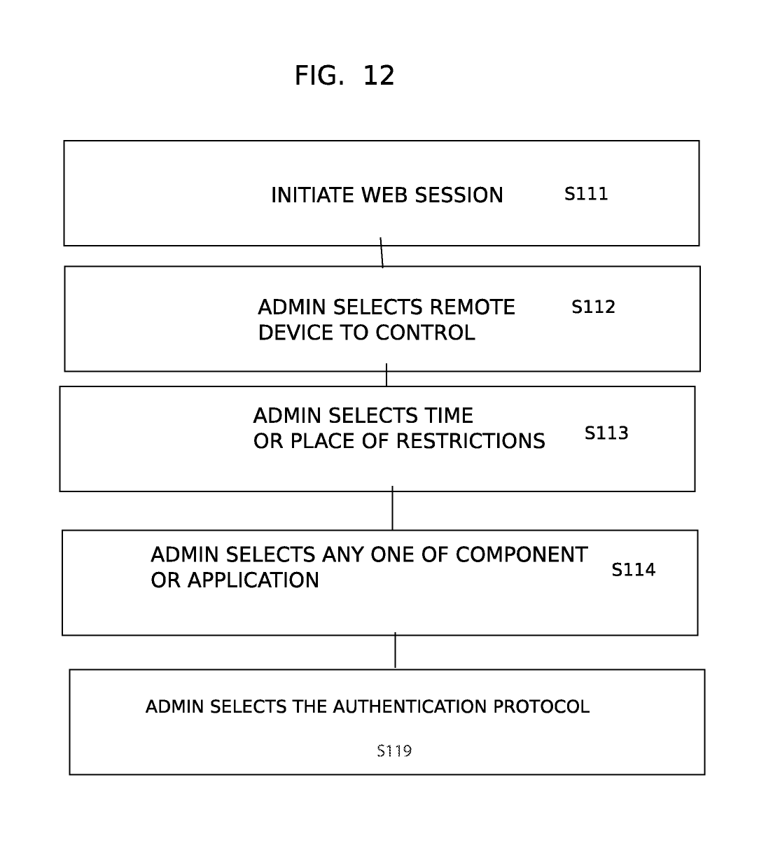

FIG. 12 is a flow chart of another embodiment for controlling remote devices. For example, steps S111-S114 are described above. In addition, step S119 this includes the administrator setting a pre-set set of protocols for setting the authentication or login. For example, included in this process for authentication could be biometric authentication, or pass code authentication, or having an additional chip or sim card to register for authentication. In addition, regardless of the different types of authentication, the system can pre-set an order for authentication as well such as setting first a voice authentication, following by fingerprint authentication, followed by passcode authentication as well as a component for authentication such as an additional chip or sim card. The order for these steps for authentication can be in essence a form of authentication as well.

As the administrator can control for this authentication, by changing the order for this authentication and by setting the authentication protocols in advance. In this way the system can be set such that it is pre-set in a highly secure manner. Thus, for authentication, an additional SIM card such as SIM card 716 can be added to the system such as that shown in FIG. 7. This additional SIM card such as SIM card 716a can be an authentication SIM card which is used to assist in providing authentication to the device. This SIM card can be plugged into the motherboard to provide additional authentication security for the device.

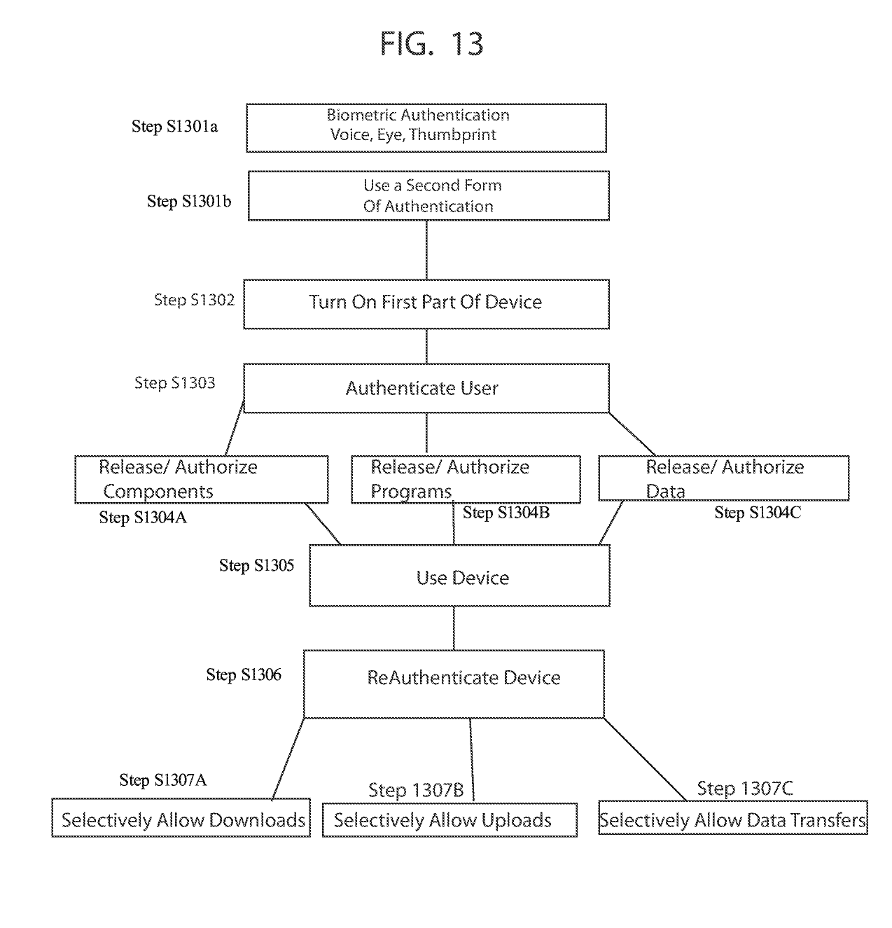

FIG. 13 shows the different forms of authentication methods that can be used to selectively control the device. For example, there is shown a step 1301a which includes using biometric authentication such as voice, eye (retinal scan), thumbprint, facial scan, or any other suitable biometric authentication. Alternatively, other security or authentication methods can be used. In step S1301b the other forms of biometric authentication can be used. Alternatively, a passcode, and/or a proximity sensor can be used. For example, a proximity sensor in the form of a watch or other wearable device can be used to separately authenticate the device. Another form or method or means of controlling the remote device can be through a required periodic authentication with a remote server. For example, step S1301b the system can require an intermittent communication with a remote server so that this remote server allows for the continued use of the device. This type of intermittent communication would then prevent a user from trying to “jailbreak” or remove a controlling application on the device. Thus, if the device had a controlling program to enforce a proper authentication, and that controlling program had a particular form of communication with a remote server, if this controlling program is removed by a user, the remote device can be set to automatically shut down if it does not remain in intermittent contact with the remote server.

Once this device is authenticated, this authentication can then be used to turn on a first part of a device in step 1302. Next, another form of authentication can be used in step S1303. This form of secondary authentication can be in the form of an auxiliary form of biometric authentication, such as an alternative retinal, thumbprint, voice recognition, or facial scan. Alternative forms of authentication can be in the form of a passcode, a communication from a SIM card or other peripheral electronic device, such as location and time designation, passwords which involve letters only, passwords which involve numbers only, passwords that involve symbols only, or combinations of the letters, numbers and symbols formed into a passcode.

This next level of authentication is then used to release certain components of the device in step S1304A, or to alternatively release or authorize certain programs on the device in step S1304B, or to release or authorize certain types of data in step S1304C.

Once the different components, programs and/or data has been released, the user can then use the device in step S1035. If the user needed to re-authenticate the device in step S1306, the user could proceed back to steps 1301a and 1301b.

For example, if the user needed to send or receive data into the device the user may have to re-authenticate the device in step S1306. Next, once the user is authenticated to handle particular data, the user could in step S1307a allow for additional downloads. Alternatively, in step S1307b the user could selectively allow for uploads of data from the device. Alternatively, in step S1307c the user could selectively allow for data transfers from his/her device to another device. Thus, these varying levels of authentication would selectively allow the user to have a secure device having varying levels of security for operating a device. These varying levels of security would protect the user from any hacking, while also further protecting the user's data.

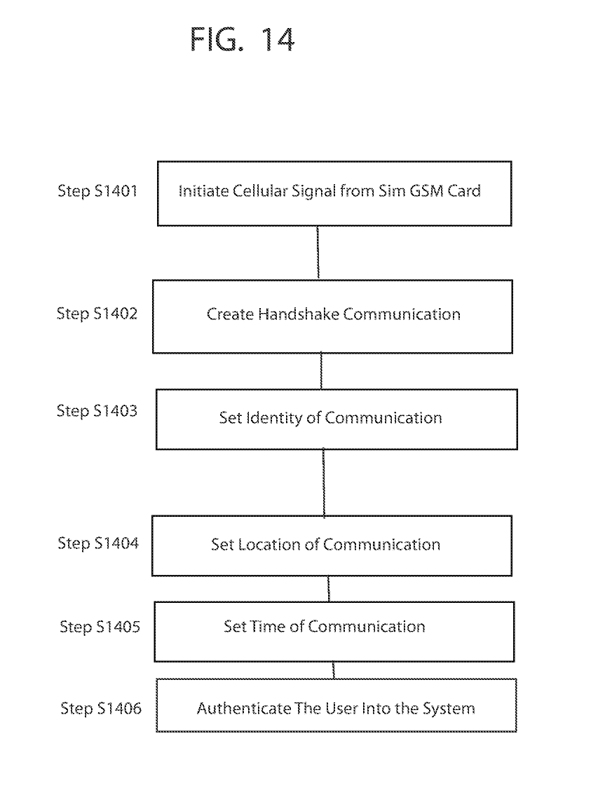

FIG. 14 shows a flow chart for authenticating a device using a SIM/GSM card. This process can be an extension of step S1301b. For example, in step S1401 the device can initiate a cellular signal from a SIM or GSM card. Next, in step S1402 the system can create a handshake communication between the device having the SIM/GSM card and a remotely operating device. Next, in step S1403 the system can set the identity of the device by reviewing the identity information on the SIM/GSM device to determine the identity of the SIM/GSM card. Next, in step S1404 the system can set the location of the communication of the device having the SIM/GSM card. This can be done by determining via triangulation the location of the user and the device via a triangulation of the cellular towers. Next, in step S1405 the system can also determine the time of the communication as well. Thus, this type of handshake communication can be used authenticate the user into the system in step 1406.

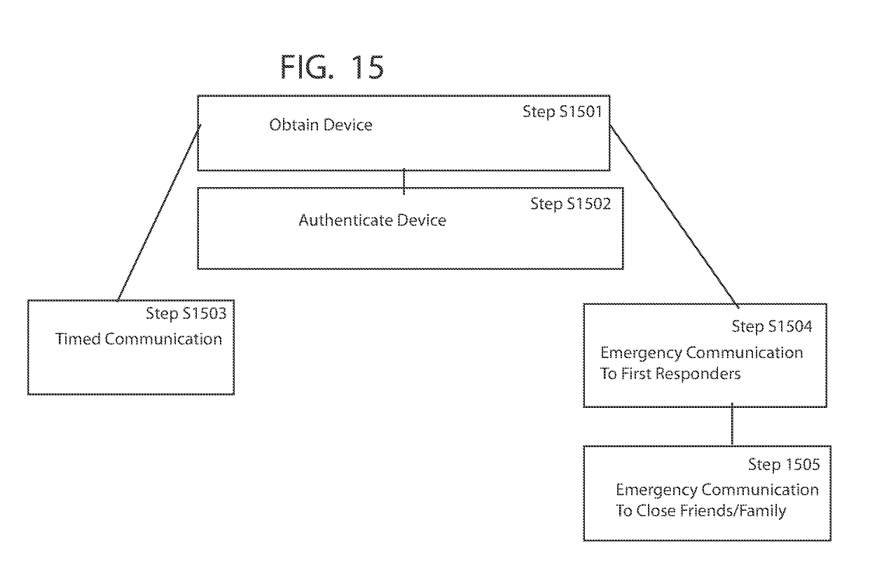

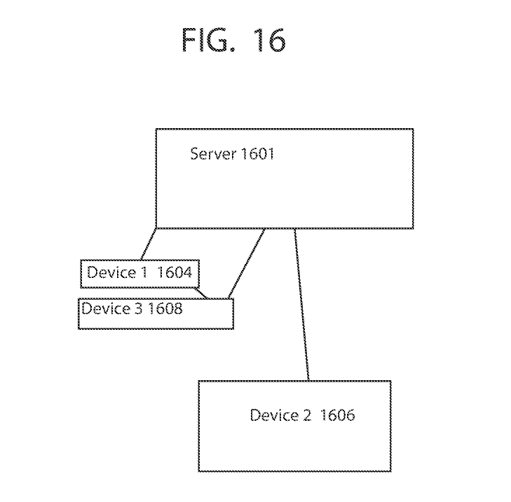

FIG. 15 shows another flow chart which shows a process for controlling the use of a portable telephone or portable device. For example, in step S1501 the user can obtain a device. Next, in step S1502 the user can be authenticated to the device. In this case, the level of authentication can be as shown by way of example in the flow chart of FIG. 13.

Alternatively, if the user does not have time to authenticate to the device or does not have rights to the use the device, the device can be set so that in step S1503 it allows for a short time access to the use of the device such as to a keypad. This may be in the form of allowing the user to use the keypad for as short as 10 seconds, or 20 seconds or even a minute. Alternatively, the device can be set so that it is set so that it allows for emergency communication to first responders in step S1504, or alternatively it can be set to allow for emergency or temporary communication to a select contact list such as to close friends and/or families. Authentication in this instance can be through a simplified password or authentication procedure such as outlined both above and below in any one of the disclosed processes for authentication.

In another embodiment, there is a peripheral password system and method. In this design, there can be multiple devices, wherein these multiple devices can comprise a server 1601, a first device 1604, a second device 1606, and an optional third device 1608. In this case, the server 1601 provides authentication for at least one or more of the remote devices. For example, the server 1601 would be in contact with the first device such as a laptop 1604. The second device 1606 is in the form of a portable device such as a telephone. The third device 1608 can be in the form of a thumb drive which is configured to be inserted into either the laptop or the cellular telephone. In at least one version of this embodiment, when the cellular telephone is positioned within an adjacent position to the laptop the presence of the cellular telephone can be used to authorize access to the laptop. In another version of this embodiment, it can require the presence of a thumb drive which can be inserted in to the computer such that the presence of the thumb drive as well as the presence of the cellular telephone can be used to unlock the laptop computer.

Alternatively, further security can be included in this system. For example, these three devices can be opened only during a pre-defined period of the day, or only opened in a particular location, or only opened at a particular location. The different forms of authentication procedures and protocols are outlined in FIG. 5 of this design.

Alternatively, another form or procedure that can be used to authenticate is that if the user has a portable device such as a telephone such as with the second device 1606 or a laptop 1604, the user can be authenticated by selecting particular names out of a contact list. By selecting the names out of the contact list, the system such as the server 1601 can then also control authentication of the device.

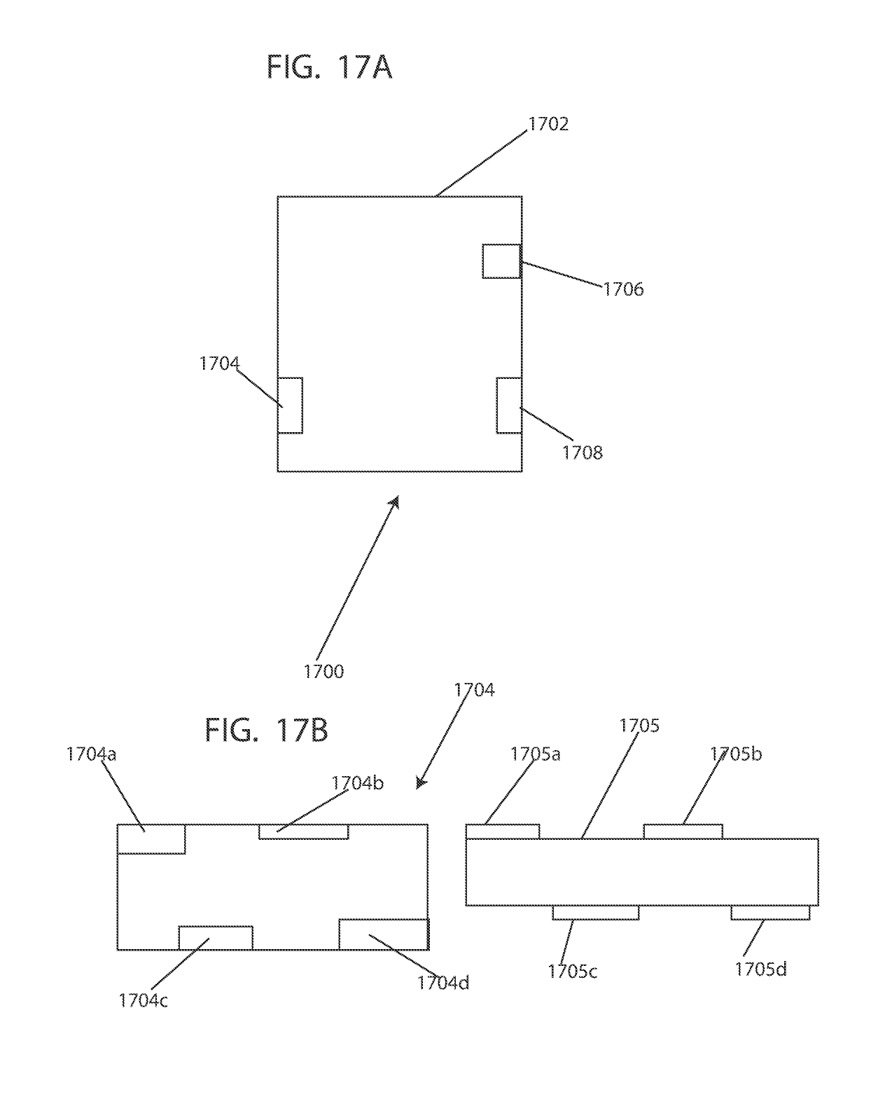

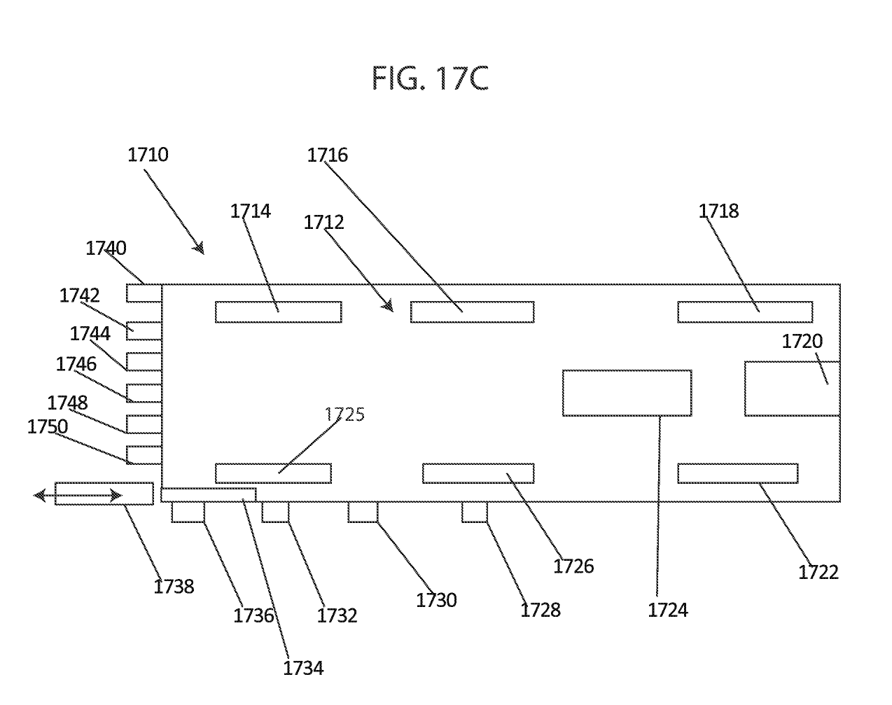

FIG. 17A shows anther design, which discloses a central board 1702 with peripheral plug in elements for forming a docking station. Thus, when different electrical components are plugged into the docking station such as the first device 1604 or a second device 1606 or a third device 1608, the docking station 1700 can be used to coordinate the authentication of all of these devices together to unlock these different devices. Thus, as shown in this docking station These devices can be configured such that once they are coupled together through the docking station, there are a plurality of interfaces such as interfaces 1704, 1706 or 1708 which allow the different remote devices to be coupled to this docking station. Once these objects are docked to the docking station, they can be configured to communicate with each other as well as with the server 1601 so that these separate devices can be authenticated and allow for intercommunication between these devices.

As shown in FIG. 17B there is shown a single interface for the docking station. For example, this single interface such as interface 1704 can include a plurality of interfaces such as interfaces 1704a, 1704b, 1704c and 1704d which serve as a lock which can be configured to receive an associated key 1705 which is configured to be inserted into this lock. Thus, associated key 1705 can have associated interfaces 1705a, 1705b, 1705c, and 1705d which are configured to match or mate with an interface 1704 forming a lock. Key 1705 can be in the form of a USB type communication device such as that shown as the third device 1608. Thus, the devices can be either positioned adjacent to each other, in direct communication with each other or with some positioned adjacent to the other while the other is connected to the docking station so that these different devices are all in communication with each other.

FIG. 17C shows another embodiment of a lock and a key type system. For example, there is a card such as card 1710, having a motherboard 1712 which is configured to hold a plurality of discrete memory chips 1714, 1716, 1718, 1720, 1722, 1724, 1725. These different memory chips are configured to hold discrete sets of information which can be unlocked by key 1738 when it is inserted into lock 1734. In addition, there are a plurality of prongs 1736, 1732, 1730, 1728 that are configured to allow the card 1710 to be inserted into another motherboard such as into a motherboard of a computer (desktop pc) a laptop or any other suitable electronic device. In addition, there are also a plurality of additional keys 1740, 1742, 1744, 1746, 1748, and 1750 which are configured to selectively lock or unlock the data in the memory chips 1714, 1716, 1718, 1720, 1722, 1724, and 1725.

Depending on the insertion of these keys, information can then flow from an external source such as from these keys into memory such as memory chips 1714, 1716, 1718, 1720, 1722, 1724, and 1725 and then out to prongs 1736, 1732, 1739 and 1728 and into an associated motherboard so that a user can use this information.

This card which forms a lock and key type system can be used with the password and biometric authentication systems mentioned above so that through a pre-set order of inserting keys as well as a pre-set order of providing passwords will provide selective authentication allowing selective release of information.

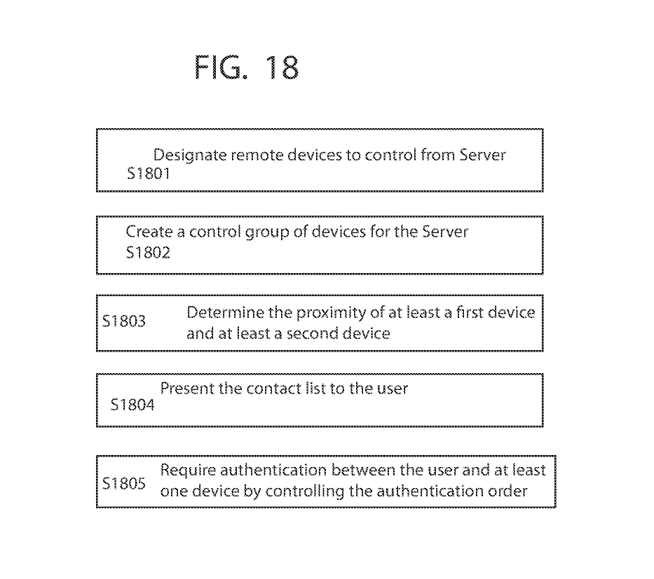

For example, as shown in FIG. 18 in at least one embodiment the process can be as follows, first the server 1601 would designate remote devices to control in step S1801. Next, in step S1802 the system can create a control group of devices for the server 1601. For example, this control group is a separate listing of devices that are controlled as a group. This group can be in the form of two or three remote devices which are designated as owned by the same owner or controlled by the same owner. In this example, this list could include a first device 1604, a second device 1606 and a third device 1608 which can be included in a single group of devices. Once these devices are joined in a group they can be used to control authentication with each other. This control can be by associating these devices in proximity with each other so that they provide a signal such as a Bluetooth signal or a nearfield communication signal or any other type of wireless signal to allow for identification and/or authentication. Next, in step S1803 the system can determine the proximity of at least one first device to at least one second device. Next, in step S1804 the system can present the contact list to the user. This contact list could be a mixture of actual contacts and fake contacts. If the user selects the actual contacts from the fake contacts, then the user would be granted authentication. Alternatively, the user could have a pre-defined order for selecting his/her contacts in order to gain authentication such as that disclosed in step S1805.

Thus, there is designed a highly secure device that has authentication controlled by other devices as well as passwords so that other unauthorized users cannot gain access to this device.

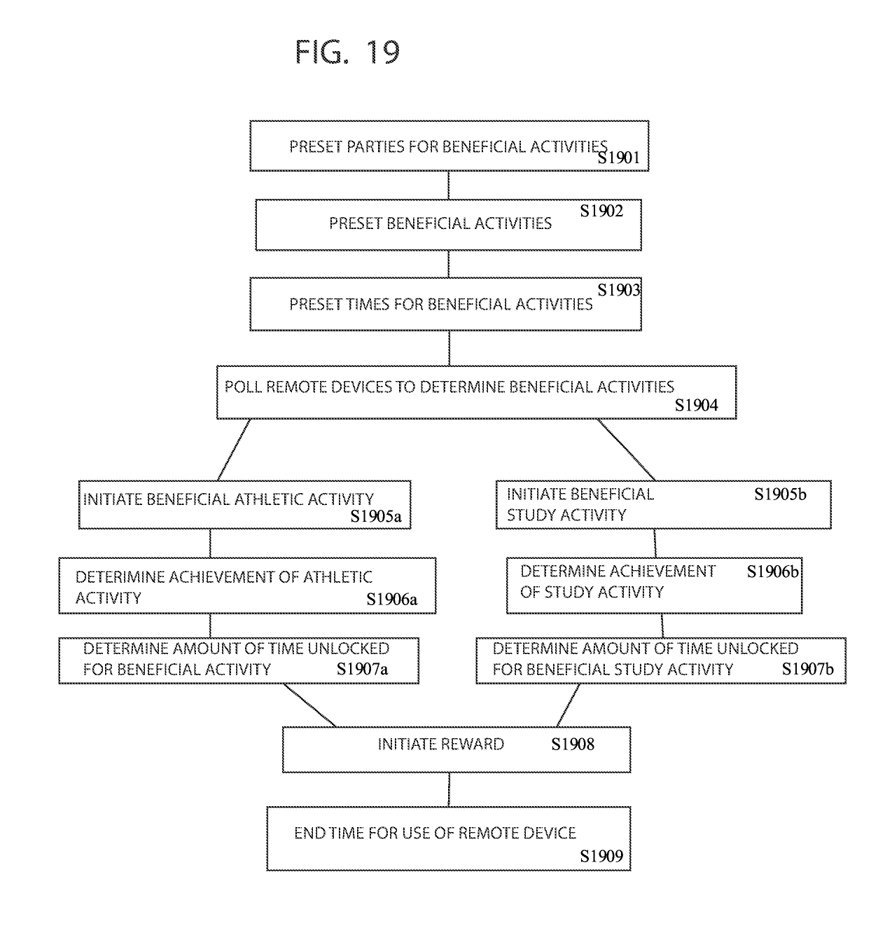

FIG. 19 is a flow chart for controlling the amount of time that a user has on a remote device. For example, step S1901 comprises providing a preset list of users for unlocking the remote device based upon beneficial activities. Next, in step S1902 the process involves setting those preset activities that the user can engage in. These beneficial activities could be in the form of athletic activities or study activities. Next, in step S1903 the process includes setting preset times for beneficial activities. Thus the user must complete these beneficial activities within a pre-set time range. Next, in step S1904 the process includes polling the remote devices for these different beneficial activities. Next, in step S1905a the beneficial activity that could be initiated could be an athletic activity. Next, in step S1905b the beneficial activity could be a study activity.

Step 1906a involves the central computing system determining the level of achievement of the athletic activity. Thus, if the user runs a mile or two miles or elevates his/her heart rate to a predetermined level for a predetermined duration then that user could be rewarded for more time based upon the level of achievement. Next in step S1907a the system could determine the amount of time that is unlocked for the user. Next, in step S1908 the system could initiate the reward which could include rewarding the user with additional screen time. Next, in step S1909 the system could calculate the end time for use of the remote device. During these steps, the process for tracking the user's athletic activity could include tracking biometric functions of the user such as heart rate, pulse, or distance traveled via remote devices such as an oximeter, a heart rate monitor or gps tracking device. In at least one embodiment, the remote device can comprise a cellular telephone which has a gps tracking device.

Alternatively, if the system was to reward the user with time on the remote device due to study activity in step S1905b, the system could determine the achievement of the study activity in step 1906b. This determination could be through determining whether the user answered a number of questions correctly. Next, in step S1907b the system could determine the amount of time that is unlocked for the user based upon the beneficial study activity. In step S1908, the system could initiate a reward for the user while in step S1909 the system could then determine an end time for the use of the device.

Accordingly, while at least one embodiment of the present invention has been shown and described, it is obvious that many changes and modifications may be made thereunto without departing from the spirit and scope of the invention.

What is claimed is:

1. A process for remotely controlling an electronic device comprising the following steps:
a) presenting a login screen;
b) presenting a plurality of different login steps comprising at least one of a password and an additional login step;
c) connecting the device to a remote server to confirm the password and the identity of the user; and
d) unlocking at least one application upon a confirmation of the password and the identity of the user.

2. The process as in claim 1, wherein the additional login step comprises biometric authentication of the user to determine the identity of the user.

3. The process as in claim 2, wherein the biometric authentication comprises a retinal scan of the user's retina.

4. The process as in claim 2, wherein the biometric authentication comprises a fingerprint verification of the users fingerprint.

5. The process as in claim 2, wherein the biometric authentication comprises a voice print verification of the users voice.

6. The process as in claim 2, wherein the biometric authentication comprises a visual image of the user's face.

7. The process as in claim 1, further comprising the step of providing a plurality of different login steps to authenticate the user onto the remote device.

8. The process as in claim 7, wherein said steps of providing a plurality of different login steps comprises providing at least three different login steps provided in a pre-set order.

9. The process as in claim 1, wherein said at least one additional login step comprises providing at least one key configured to selectively unlock the remote device.

10. The process as in claim 1, wherein said at least one additional login step comprises providing at least one lock as a separate device which is separate from the remote device, wherein when said at least one key is inserted into said at least one lock said key unlocks said lock and thereby unlocks said remote device.

11. The process as in claim 1, wherein said at least one additional login step comprises providing at least one additional remote device which is configured to communicate with via a close communication protocol with the remote device to selectively unlock the remote device.

12. The process as in claim 11, wherein said close communication protocol comprises at least one of Bluetooth or near field communication (NFC).

13. The process as in claim 1, wherein the additional login step comprises determining a location for the device and then selectively allowing authentication of the device based upon the location of the device.

14. The process as in claim 1, wherein after the user logs into the remote device the process further comprises the step of allowing the user a limited amount of time on the device based upon a score created by beneficial activity of the user.

15. The process as in claim 14, wherein the beneficial activity of the user is athletic activity.

16. The process as in claim 15, wherein depending on a pre-set level of athletic activity, the user can unlock additional time.

17. The process as in claim 14, wherein the beneficial activity of the user is studying a subject.

18. The process as in claim 17, wherein depending on the number of questions answered correctly the user can unlock additional time.

19. The process as in claim 1, wherein said at least one additional login step comprises pre-setting a time, a date and a location of a device for allowing a user to log into the device.
